(19) United States
(12) Patent Application Publication
(10) Pub. No.: US 2021/0117877 A1
(43) Pub. Date: Apr. 22, 2021

(54) COMPUTER SYSTEM WITH FORECAST MECHANISM AND METHOD OF OPERATION THEREOF

(71) Applicant: Atlas AI P.B.C., Palo Alto, CA (US)

(72) Inventors: Zhenong Jin, Blaine, MN (US); George Azzari, Santa Clara, CA (US); David Lobell, Stanford, CA (US)

(21) Appl. No.: 16/657,722

(22) Filed: Oct. 18, 2019

(51) Int. Cl. G06Q 10/04; G06Q 30/02

(52) U.S. Cl. CPC G06Q 10/04; G06Q 30/0202

(57) ABSTRACT

A method of operation of a computer system includes: selecting a geographic region; receiving a historical observation for the geographic region and the historical observation including a sparse observation at a past middle season; generating a climatology curve with the historical observation; and generating a crop yield forecast for the geographic region for a current middle season based on the climatology curve.

### TECHNICAL FIELD

The present invention relates generally to a computer system and more particularly to a system for computer system with a forecast mechanism.

### BACKGROUND ART

There are many factors in generating forecast models where some of the data needed is either sparse or nonexistent or varies while others fluctuate differently compared to the other factors. This is also true for agriculture forecast. Further, for forecasts to be actionable, the generation of the forecast need to cover as granular as narrow regions, such as field levels. Research and development in the existing technologies can take a myriad of different directions.

Thus, a need still remains for a computer system that can forecast regions of various geographic sizes. In view of increasing demand for better time management, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a computer system including: selecting a geographic region; receiving a historical observation for the geographic region and the historical observation including a sparse observation at a past middle season; generating a climatology curve with the historical observation; and generating a crop yield forecast for the geographic region for a current middle season based on the climatology curve.

The present invention provides a computer system including: a control circuit configured to: select a geographic region; receive a historical observation for the geographic region and the historical observation including a sparse observation at a past middle season; generate a climatology curve with the historical observation; and forecast a crop yield for the geographic region for a current middle season based on the climatology curve; and a communication circuit, coupled to the control circuit, configured to transmit the crop yield for displaying on a device.

An embodiment of the present invention provides a non-transitory computer readable medium including instructions for a computer system, including: selecting a geographic region; receiving a historical observation for the geographic region and the historical observation including a sparse observation at a past middle season; generating a climatology curve with the historical observation; and generating a crop yield forecast for the geographic region for a current middle season based on the climatology curve.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a computer system with forecast mechanism in an embodiment of the present invention.

FIG. 2 is an exemplary block diagram of the computer system in an embodiment.

FIG. 3 is an example of graphical views of pre-processing of the observations.

FIG. 4 is an example display of a forecast for the geographic region.

FIG. 5 is an example of a control flow of the computer system with the forecast mechanism.

FIG. 6 is an example of a control flow of the deploy module.

FIG. 7 is an example of a control flow of the pre-processing for climatology.

FIG. 8 is an example of a control flow of the pre-processing for weather.

FIG. 9 is a flow chart of a method of operation of a computer system in an embodiment of the present invention.

### DETAILED DESCRIPTION

In the following description, numerous specific details are set forth to provide a thorough understanding of the presently disclosed technology. In other embodiments, the techniques introduced here can be practiced without these specific details. In other instances, well-known features, such as specific functions or routines, are not described in detail in order to avoid unnecessarily obscuring the present disclosure. References in this description to “an embodiment,” “one embodiment,” or similar terms with “embodiment” mean that a particular feature, structure, material, or characteristic being described is included in at least one embodiment of the present disclosure. The appearances of such phrases in this specification do not necessarily all refer to the same embodiment. On the other hand, such references are not necessarily mutually exclusive. Furthermore, the particular features, structures, materials, or characteristics can be combined in any suitable manner in one or more embodiments.

It is to be understood that the various embodiments shown in the figures are merely illustrative representations. Further, the drawings showing embodiments of the system are semi-diagrammatic, and not to scale and, particularly, some of the dimensions are for the clarity of presentation and are shown exaggerated in the drawing figures. Similarly, although the views in the drawings for ease of description generally show similar orientations, this depiction in the figures is arbitrary for the most part. Generally, the invention can be operated in any orientation.

Several details describing structures or processes that are well-known and often associated with computer systems and subsystems, but that can unnecessarily obscure some significant aspects of the disclosed techniques, are not set forth in the following description for purposes of clarity. Moreover, although the following disclosure sets forth several embodiments of different aspects of the present technology, several other embodiments can have different configurations or different components than those described in this section. Accordingly, the disclosed techniques can have other embodiments with additional elements or without several of the elements described below.

Many embodiments or aspects of the present disclosure described below can take the form of computer-executable or controller-executable instructions, including routines executed by a programmable computer or controller or electronic devices. Those skilled in the relevant art will appreciate that the disclosed techniques can be practiced on electronic or computer or controller systems other than those shown and described below. The techniques described herein can be embodied in a special-purpose electronic or computer or data processor that is specifically programmed, configured, or constructed to execute one or more of the computer-executable instructions described below. Accordingly, the terms “computer” and “controller” as generally used herein refer to any data processor and can include servers, distributed computing systems, cloud computing, Internet appliances, and handheld devices, including palm-top computers, wearable computers, cellular or mobile phones, multi-processor systems, processor-based or programmable consumer electronics, network computers, mini computers, and the like. Information handled by these computer systems and computers and controllers can be presented at any suitable display medium, including a liquid crystal display (LCD). Instructions for executing electronic- or computer- or controller-executable tasks can be stored in or on any suitable computer-readable medium, including hardware, firmware, or a combination of hardware and firmware. Instructions can be contained in any suitable memory device, including, for example, a flash drive, USB device, and/or other suitable medium.

The terms “coupled” and “connected,” along with their derivatives, can be used herein to describe structural relationships between components. It should be understood that these terms are not intended as synonyms for each other. Rather, in particular embodiments, “connected” can be used to indicate that two or more elements are in direct contact with each other. Unless otherwise made apparent in the context, the term “coupled” can be used to indicate that two or more elements are in either direct or indirect (with other intervening elements between them) contact with each other, or that the two or more elements cooperate or interact with each other (e.g., as in a cause-and-effect relationship, such as for signal transmission/reception or for function calls), or both.

The following embodiments are described in sufficient detail to enable those skilled in the art to make and use the invention. It is to be understood that other embodiments would be evident based on the present disclosure, and that system, process, or mechanical changes may be made without departing from the scope of an embodiment of the present invention.

The term “module” or “unit” referred to herein can include software, hardware, mechanical mechanisms, or a combination thereof in an embodiment of the present invention, in accordance with the context in which the term is used. For example, the software can be machine code, firmware, embedded code, or application software. Also, for example, the hardware can be circuitry, a processor, a special purpose computer, an integrated circuit, integrated circuit cores, a pressure sensor, an inertial sensor, a microelectromechanical system (MEMS), a passive device, or a combination thereof. Furthermore, the mechanical mechanism can include actuators, motors, arms, joints, handles, end effectors, guides, mirrors, anchoring bases, vacuum lines, vacuum generators, liquid source lines, or stoppers. Further, if a “module” or “unit” is written in the system claims section below, the “module” or “unit” is deemed to include hardware circuitry for the purposes and the scope of the system claims.

The modules or units in the following description of the embodiments can be coupled or attached to one another as described or as shown. The coupling or attachment can be direct or indirect without or with intervening items between coupled or attached modules or units. The coupling or attachment can be by physical contact or by communication between modules or units.

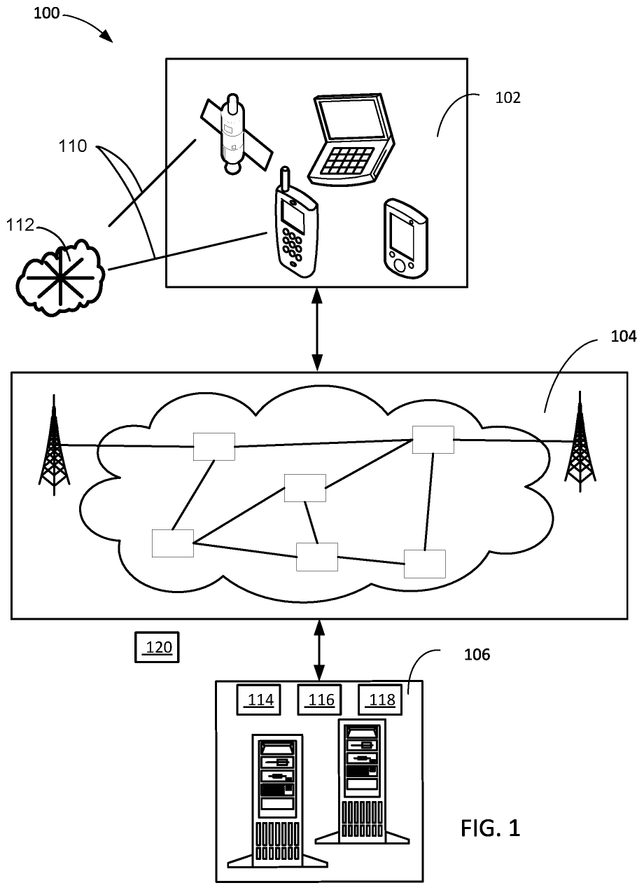

Referring now to FIG. 1, therein is shown a computer system 100 with a forecast mechanism in an embodiment of the present invention. The computer system 100 includes a first device 102, such as a satellite, a client, a server, or a device to take or compute measurements, connected to a second device 106, such as a client or server. The first device 102 can communicate with the second device 106 with a communication path 104, such as a wireless or wired network.

For example, the first device 102 can be of any of a variety of devices, such as a satellite, a measuring device, a vehicle, a computing device, a tablet computer, a smart phone, a notebook computer, or a combination thereof. The first device 102 can couple, either directly or indirectly, to the communication path 104 to communicate with the second device 106 or can be a stand-alone device.

The second device 106 can be any of a variety of centralized or decentralized computing devices, sensor devices to take measurements or record environmental information, such as sensor instruments, sensor equipment, or a sensor array. For example, the second device 106 can be a multimedia computer, a laptop computer, a desktop computer, grid-computing resources, a virtualized computer resource, cloud computing resource, routers, switches, peer-to-peer distributed computing devices, or a combination thereof.

The second device 106 can be centralized in a single room, distributed across different rooms, distributed across different geographical locations, embedded within a telecommunications network. The second device 106 can couple with the communication path 104 to communicate with the first device 102.

For illustrative purposes, the computer system 100 is described with the second device 106 as a computing device, although it is understood that the second device 106 can be different types of devices, such as a standalone sensor or measurement device. Also for illustrative purposes, the computer system 100 is shown with the second device 106 and the first device 102 as end points of the communication path 104, although it is understood that the computer system 100 can have a different partition between the first device 102, the second device 106, and the communication path 104. For example, the first device 102, the second device 106, or a combination thereof can also function as part of the communication path 104.

The communication path 104 can span and represent a variety of networks and network topologies. For example, the communication path 104 can include wireless communication, wired communication, optical, ultrasonic, or a combination thereof. Satellite communication, cellular communication, Bluetooth, Infrared Data Association standard (lrDA), wireless fidelity (WiFi), and worldwide interoperability for microwave access (WiMAX) are examples of wireless communication that can be included in the communication path 104. Ethernet, digital subscriber line (DSL), fiber to the home (FTTH), and plain old telephone service (POTS) are examples of wired communication that can be included in the communication path 104. Further, the communication path 104 can traverse a number of network topologies and distances. For example, the communication path 104 can include direct connection, personal area network (PAN), local area network (LAN), metropolitan area network (MAN), wide area network (WAN), or a combination thereof.

As a specific example, the first device 102 can take observations 110 for a geographic region 112. In this example, the first device 102 can function as a satellite, ground measurement device, or a combination thereof. The observations 110 provides information captured by, processed by, or a combination thereof by the first device 102.

As an example, the observations 110 can include information related to or associated with vegetation at the geographic region 112. Also for example, the observations 110 can represent weather conditions related to or associated with the geographic region 112. As specific example, the weather conditions can include amount, duration, frequency, or a combination thereof of rainfall. Also as a specific example, the observations 110 can represent weather conditions relating to cloud cover over the geographic region 112. Further for example, the observations 110 can also include sensor captures of the geographic region 112 captured by the first device 102. The sensor captures can include images, video, audio, thermal, or a combination thereof of the geographic region 112.

The observations 110 can include an annotation 114. The annotation 114 represents information about each of the observations 110 related to or associated with the sensor captures, measurements, or a combination thereof. For example, the annotation 114 can include time, date, the geographic region 112, or a combination thereof to be associated with each of the observations 110.

Also for example, the annotation 114 can reference the observations 110 to each other, such as the relationship of the observations 110 to each other including time series or date sequence. As a specific example, the annotation 114 can indicate a seasonal group 116 for portions of the observations 110, a historical observation 118, a current observation 120, or a combination thereof. The seasonal group 116 can provide a category for the observations 110, the historical observation 118, the current observation 120, or a combination thereof within a single season or phases within a season. As an example, the seasonal group 116 can be categorized in terms of a calendar year or a crop season.

As a further example, the annotation 114 can reference different types of the observations 110 with other types related to or associated with the geographic region 112. As a specific example, the annotation 114 can relate the observations 110 of weather conditions, images, soil conditions, vegetation index, thermal information, or a combination thereof by time, date, the geographic region 112, or a combination thereof. Yet further for example, the annotation 114 can relate the observations 110 from different types of devices to take the sensor capture or measures as appropriate based on a number factors, including time, date, the geographic region 112, or a combination thereof.

The observations 110 can be stored as the historical observation 118, the current observation 120, or a combination thereof. The historical observation 118 can be stored by the computer system 100 for later use or reference. The term “historical” can reference a number temporal lags or delays, such as one or multiple years, months, weeks, days, or a combination thereof. The term “historical” can be referenced by events or time periods, such as seasons of a calendar, crop seasons, lunar cycles, or a combination thereof. The term “current” can reference a number of contemporaneous time relative to the moment the observations 110 was captured and can also be reference based on time as well as events similar to the term “historical”.

The geographic region 112 represents a physical geographic area. The size of the geographic region 112 is not necessarily fixed. For example, the geographic region 112 can represent a country, a province, a state, a county, a city, a neighborhood, a farming region, a farm, a field, or a combination thereof.

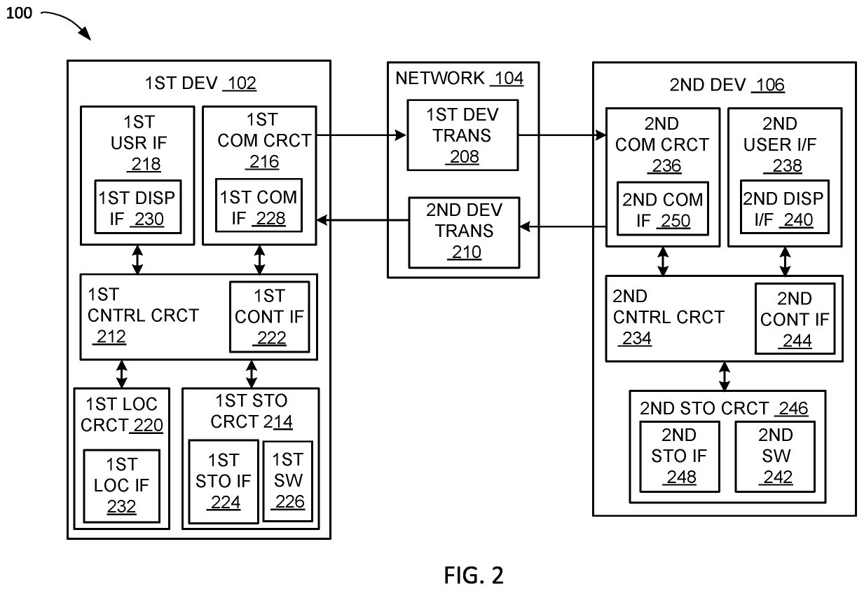

Referring now to FIG. 2, therein is shown an exemplary block diagram of the computer system 100. The computer system 100 can include the first device 102, the communication path 104, and the second device 106. The first device 102 can send information in a first device transmission 208 over the communication path 104 to the second device 106. The second device 106 can send information in a second device transmission 210 of FIG. 2 over the communication path 104 to the first device 102.

For illustrative purposes, the computer system 100 is shown with the first device 102 as a mobile device, a satellite, a measuring device, although it is understood that the computer system 100 can include the first device 102 as a different type of device. For example, the first device 102 can include a non-mobile device or a server.

Also for illustrative purposes, the computer system 100 is shown with the second device 106 as a non-mobile device, although it is understood that the computer system 100 can include the second device 106 as a different type of device. For example, the second device 106 can be a mobile device.

Further for illustrative purposes, the computer system 100 is shown with interaction between the first device 102 and the second device 106, although it is understood that the first device 102 can similarly interact another instance of the first device 102. Similarly, the second device 106 can similarly interact with another instance of the second device 106.

For brevity of description in this embodiment of the present invention, the first device 102 will be described as a mobile device and the second device 106 will be described as a non-mobile device. The embodiment of the present invention is not limited to this selection for the type of devices. The selection is an example of an embodiment.

The first device 102 can include a first control circuit 212, a first storage circuit 214, a first communication circuit 216, and a first user interface 218, and a first location circuit 220. The first control circuit 212 can include a first control interface 222. The first control circuit 212 can execute a first software 226 o to provide the intelligence of the computer system 100.

The first control circuit 212 can be implemented in a number of different manners. For example, the first control circuit 212 can be a processor, an application specific integrated circuit (ASIC) an embedded processor, a microprocessor, a hardware control logic, a hardware finite state machine (FSM), a digital signal processor (DSP), or a combination thereof. The first control interface 222 can be used for communication between the first control circuit 212 and other functional units or circuits in the first device 102. The first control interface 222 can also be used for communication that is external to the first device 102.

The first control interface 222 can receive information from the other functional units/circuits or from external sources, or can transmit information to the other functional units/circuits or to external destinations. The external sources and the external destinations refer to sources and destinations external to the first device 102.

The first control interface 222 can be implemented in different ways and can include different implementations depending on which functional units/circuits or external units/circuits are being interfaced with the first control interface 222. For example, the first control interface 222 can be implemented with a pressure sensor, an inertial sensor, a microelectromechanical system (MEMS), optical circuitry, waveguides, wireless circuitry, wireline circuitry, or a combination thereof.

The first storage circuit 214 can store the first software 226. The first storage circuit 214 can also store the relevant information, such as the observations 110 of FIG. 1, data representing incoming images, data representing previously presented image, sound files, or a combination thereof.

The first storage circuit 214 can be a volatile memory, a nonvolatile memory, an internal memory, an external memory, or a combination thereof. For example, the first storage circuit 214 can be a nonvolatile storage such as non-volatile random access memory (NVRAM), Flash memory, disk storage, or a volatile storage such as static random access memory (SRAM).

The first storage circuit 214 can include a first storage interface 224. The first storage interface 224 can be used for communication between the first storage circuit 214 and other functional units or circuits in the first device 102. The first storage interface 224 can also be used for communication that is external to the first device 102.

The first storage interface 224 can receive information from the other functional units/circuits or from external sources, or can transmit information to the other functional units/circuits or to external destinations. The external sources and the external destinations refer to sources and destinations external to the first device 102.

The first storage interface 224 can include different implementations depending on which functional units/circuits or external units/circuits are being interfaced with the first storage circuit 214. The first storage interface 224 can be implemented with technologies and techniques similar to the implementation of the first control interface 222.

The first communication circuit 216 can enable external communication to and from the first device 102. For example, the first communication circuit 216 can permit the first device 102 to communicate with the second device 106 of FIG. 1, an attachment, such as a peripheral device or a sensor, and the communication path 104.

The first communication circuit 216 can also function as a communication hub allowing the first device 102 to function as part of the communication path 104 and not limited to be an end point or terminal circuit to the communication path 104. The first communication circuit 216 can include active and passive components, such as microelectronics or an antenna, for interaction with the communication path 104.

The first communication circuit 216 can include sensors to capture the observations 110 of FIG. 1. Examples of these sensors can include image or multimedia recording device, optical sensors, or a combination thereof. The first control circuit 212 can embed or associate the annotation 114 of FIG. 1 with the observations 110.

The first communication circuit 216 can include a first communication interface 228. The first communication interface 228 can be used for communication between the first communication circuit 216 and other functional units or circuits in the first device 102. The first communication interface 228 can receive information from the other functional units/circuits or can transmit information to the other functional units or circuits.

The first communication interface 228 can include different implementations depending on which functional units or circuits are being interfaced with the first communication circuit 216. The first communication interface 228 can be implemented with technologies and techniques similar to the implementation of the first control interface 222.

The first user interface 218 allows a user (not shown) to interface and interact with the first device 102. The first user interface 218 can include an input device and an output device. Examples of the input device of the first user interface 218 can include a keypad, a touchpad, soft-keys, a keyboard, a microphone, an infrared sensor for receiving remote signals, or any combination thereof to provide data and communication inputs.

The first user interface 218 can include a first display interface 230. The first display interface 230 can include an output device. The first display interface 230 can include a display, a projector, a video screen, a speaker, or any combination thereof.

The first control circuit 212 can operate the first user interface 218 to display information generated by the computer system 100. The first control circuit 212 can also execute the first software 226 for the other functions of the computer system 100, including receiving location information from the first location circuit 220. The first control circuit 212 can further execute the first software 226 for interaction with the communication path 104 via the first communication circuit 216.

The first location circuit 220 can generate location information, current heading, current acceleration, and current speed of the first device 102, as examples. The first location circuit 220 can be implemented in many ways. For example, the first location circuit 220 can function as at least a part of the global positioning system, an inertial computer system, a cellular-tower location system, a pressure location system, or any combination thereof. Also, for example, the first location circuit 220 can utilize components such as a global positioning system (GPS) receiver or an accelerometer.

The first location circuit 220 can include a first location interface 232. The first location interface 232 can be used for communication between the first location circuit 220 and other functional units or circuits in the first device 102. The first location interface 232 can also be used for communication external to the first device 102.

The first location interface 232 can receive information from the other functional units/circuits or from external sources, or can transmit information to the other functional units/circuits or to external destinations. The external sources and the external destinations refer to sources and destinations external to the first device 102.

The first location interface 232 can include different implementations depending on which functional units/circuits or external units/circuits are being interfaced with the first location circuit 220. The first location interface 232 can be implemented with technologies and techniques similar to the implementation of the first control circuit 212.

The second device 106 can be optimized for implementing an embodiment of the present invention in a multiple device embodiment with the first device 102. The second device 106 can provide the additional or higher performance processing power compared to the first device 102. The second device 106 can include a second control circuit 234, a second communication circuit 236, a second user interface 238, and a second storage circuit 246.

The second user interface 238 allows a user (not shown) to interface and interact with the second device 106. The second user interface 238 can include an input device and an output device. Examples of the input device of the second user interface 238 can include a keypad, a touchpad, soft-keys, a keyboard, a microphone, or any combination thereof to provide data and communication inputs. Examples of the output device of the second user interface 238 can include a second display interface 240. The second display interface 240 can include a display, a projector, a video screen, a speaker, or any combination thereof.

The second control circuit 234 can execute a second software 242 of FIG. 2 to provide the intelligence of the second device 106 of the computer system 100. The second software 242 can operate in conjunction with the first software 226. The second control circuit 234 can provide additional performance compared to the first control circuit 212.

The second control circuit 234 can operate the second user interface 238 to display information. The second control circuit 234 can also execute the second software 242 for the other functions of the computer system 100, including operating the second communication circuit 236 to communicate with the first device 102 over the communication path 104.

The second control circuit 234 can be implemented in a number of different manners. For example, the second control circuit 234 can be a processor, an embedded processor, a microprocessor, hardware control logic, a hardware finite state machine (FSM), a digital signal processor (DSP), or a combination thereof.

The second control circuit 234 can include a second control interface 244 of FIG. 2. The second control interface 244 can be used for communication between the second control circuit 234 and other functional units or circuits in the second device 106. The second control interface 244 can also be used for communication that is external to the second device 106.

The second control interface 244 can receive information from the other functional units/circuits or from external sources, or can transmit information to the other functional units/circuits or to external destinations. The external sources and the external destinations refer to sources and destinations external to the second device 106.

The second control interface 244 can be implemented in different ways and can include different implementations depending on which functional units/circuits or external units/circuits are being interfaced with the second control interface 244. For example, the second control interface 244 can be implemented with a pressure sensor, an inertial sensor, a microelectromechanical system (MEMS), optical circuitry, waveguides, wireless circuitry, wireline circuitry, or a combination thereof.

The second storage circuit 246 can store the second software 242. The second storage circuit 246 can also store the information such as data representing incoming images, data representing previously presented image, sound files, or a combination thereof. The second storage circuit 246 can be sized to provide the additional storage capacity to supplement the first storage circuit 214.

For illustrative purposes, the second storage circuit 246 is shown as a single element, although it is understood that the second storage circuit 246 can be a distribution of storage elements. Also for illustrative purposes, the computer system 100 is shown with the second storage circuit 246 as a single hierarchy storage system, although it is understood that the computer system 100 can include the second storage circuit 246 in a different configuration. For example, the second storage circuit 246 can be formed with different storage technologies forming a memory hierarchal system including different levels of caching, main memory, rotating media, or off-line storage.

The second storage circuit 246 can be a volatile memory, a nonvolatile memory, an internal memory, an external memory, or a combination thereof. For example, the second storage circuit 246 can be a nonvolatile storage such as non-volatile random access memory (NVRAM), Flash memory, disk storage, or a volatile storage such as static random access memory (SRAM).

The second storage circuit 246 can include a second storage interface 248. The second storage interface 248 can be used for communication between the second storage circuit 246 and other functional units or circuits in the second device 106. The second storage interface 248 can also be used for communication that is external to the second device 106.

The second storage interface 248 can receive information from the other functional units/circuits or from external sources, or can transmit information to the other functional units/circuits or to external destinations. The external sources and the external destinations refer to sources and destinations external to the second device 106.

The second storage interface 248 can include different implementations depending on which functional units/circuits or external units/circuits are being interfaced with the second storage circuit 246. The second storage interface 248 can be implemented with technologies and techniques similar to the implementation of the second control interface 244.

The second communication circuit 236 can enable external communication to and from the second device 106. For example, the second communication circuit 236 can permit the second device 106 to communicate with the first device 102 over the communication path 104.

The second communication circuit 236 can also function as a communication hub allowing the second device 106 to function as part of the communication path 104 and not limited to be an end point or terminal unit or circuit to the communication path 104. The second communication circuit 236 can include active and passive components, such as microelectronics or an antenna, for interaction with the communication path 104.

The second communication circuit 236 can include a second communication interface 250. The second communication interface 250 can be used for communication between the second communication circuit 236 and other functional units or circuits in the second device 106. The second communication interface 250 can receive information from the other functional units/circuits or can transmit information to the other functional units or circuits.

The second communication interface 250 can include different implementations depending on which functional units or circuits are being interfaced with the second communication circuit 236. The second communication interface 250 can be implemented with technologies and techniques similar to the implementation of the second control interface 244.

The first communication circuit 216 can couple with the communication path 104 to send information to the second device 106 in the first device transmission 208. The second device 106 can receive information in the second communication circuit 236 from the first device transmission 208 of the communication path 104.

The second communication circuit 236 can couple with the communication path 104 to send information to the first device 102 in the second device transmission 210. The first device 102 can receive information in the first communication circuit 216 from the second device transmission 210 of the communication path 104. The computer system 100 can be executed by the first control circuit 212, the second control circuit 234, or a combination thereof. For illustrative purposes, the second device 106 is shown with the partition containing the second user interface 238, the second storage circuit 246, the second control circuit 234, and the second communication circuit 236, although it is understood that the second device 106 can include a different partition. For example, the second software 242 can be partitioned differently such that some or all of its function can be in the second control circuit 234 and the second communication circuit 236. Also, the second device 106 can include other functional units or circuits not shown in FIG. 2 for clarity.

The functional units or circuits in the first device 102 can work individually and independently of the other functional units or circuits. The first device 102 can work individually and independently from the second device 106 and the communication path 104.

The functional units or circuits in the second device 106 can work individually and independently of the other functional units or circuits. The second device 106 can work individually and independently from the first device 102 and the communication path 104.

The functional units or circuits described above can be implemented in hardware. For example, one or more of the functional units or circuits can be implemented using the a gate, circuitry, a processor, a computer, integrated circuit, integrated circuit cores, a pressure sensor, an inertial sensor, a microelectromechanical system (MEMS), a passive device, a physical non-transitory memory medium containing instructions for performing the software function, a portion therein, or a combination thereof.

For illustrative purposes, the computer system 100 is described by operation of the first device 102 and the second device 106. It is understood that the first device 102 and the second device 106 can operate any of the modules and functions of the computer system 100.

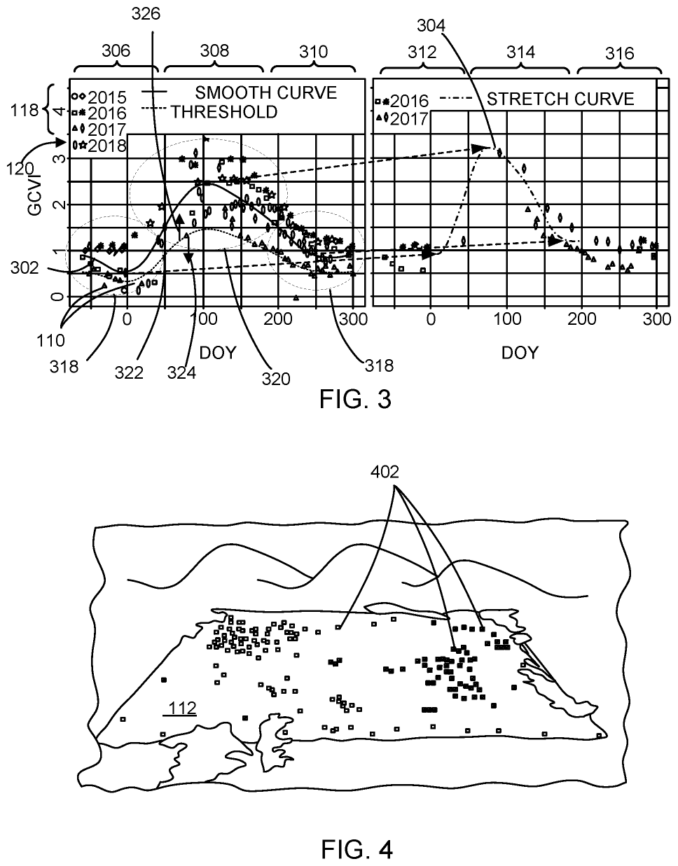

Referring now to FIG. 3, therein is shown an example of graphical views of pre-processing of the observations 110. The term “pre-processing” refers to processing input for training the forecast mechanism of the computer system 100. FIG. 3 depicts graphical representations for some portions of pre-processing the observations 110.

The graph at the left-side of FIG. 3 depicts a smooth curve 302 generated by pre-processing the observations 110. The graph at the right-side of FIG. 3 depicts a stretch curve 304 generated from the smooth curve 302.

Both examples in the left-side graph and the right-side graph depict the x-axis representing time. In this example, the x-axis is labeled as “DOY” or Day of Year. Both graphs can also be depicted with the x-axis in terms of seasonal phases for a crop season and not dates or day of a calendar. The x-axis can also be represented in terms of thermal unit, e.g. GDD or other variant of thermal time such as photothermal time such as accumulated phototime (APTT), where photothermal time can include a combination of both temperature and photoperiod information was used to describe leaf appearance rate and phenological response of various plant species. For example, the graphs can be shown with the x-axis as a past early season 306, a past middle season 308, and a past end season 310. Also for example, the graphs can also be shown with the x-axis as a current early season 312, a current middle season 314, and a current end season 316.

The term “early”, “middle”, and “end” represent a time period relative to a portion of a crop season. The term “past” and “current” can represent the same or approximately the same time period within a crop season. The “past” term refers to the historical observation 118 for past years, in this example, 2015 to 2017. The “current” term refers to the current observation 120 for the current year, in this example, 2018.

In this example, the graph at the left-side depicts the pre-processing of the observations 110 including the historical observation 118 and the current observation 120. This example shows the historical observation 118 including years 2015, 2016, and 2017. Depicted in FIG. 3, the observations 110 for 2018 can be considered as the current observation 120, as an example.

In this example, the y-axis is labeled as green chlorophyll vegetation index (GCVI), which is an example of a measurement for vegetation index that can be obtained by remote sensing with the first device 102 as a satellite. The higher value along the y-axis indicates the higher the vegetation or crop yield. Also in this example, the historical observation 118 in the past early season 306, the past end season 310, or a combination thereof is shown with a non-sparse observation 318. Continuing with this example, the historical observation 118 in the past middle season 308 is shown with a sparse observation 320.

The sparse observation 320 represents the number of the observations 110 or the historical observation 118 as low or zero, such as non-existing. The sparse observation 320 can be counted or categorized within a time period, individual day, or a combination thereof of a crop season. The non-sparse observation 318 represents the number of the observations 110 or the historical observation 118 as appropriately abundant and non-zero. The non-sparse observation 318 can be counted or categorized within a time period, individual day, or a combination thereof of a crop season.

The left-side graph depicts a threshold 322 depicted as a dotted curve. The threshold 322 can filter the observations 110 determined to be of a low quality 324. In the example of remoting sensing from the first device 102 being a satellite, the observations 110 can be considered of the low quality 324 due to various factors including cloud cover, haze, shadow, or a combination thereof relative to the geographic region 112.

This example depicts the threshold 322 as a curve as opposed to a line given that the value along the y-axis for vegetation index is expected to be lower at the early part of a crop season as well as towards the end of the crop season. Continuing with the crop example, the threshold 322 is shown a curve function where the maximum value along the y-axis is towards the middle of the crop season.

As shown in the example in left-side graph, there are portions of the observations 110 below the threshold 322 while others are at or above the threshold 322. The observations 110 above the threshold 322 are determined to be not of the low quality 324 but a usable quality 326. The low quality refers to the observations 110 below the threshold 322 and determined to be not usable or not reliable to generate the smooth curve 302. The usable quality 326 refers to the observations 110 at or above the threshold 322 and can be used to generate the smooth curve 302. In this example, the smooth curve 302 is a climatology curve for a smoothed multi-year averaged crop phenology curve.

The threshold 322 can be used for the historical observation 118, the current observation 120, or a combination thereof. For example, the value for the threshold 322 can be varied based on the number of or density of or distribution of the observations 110. As a further example, the threshold 322 can be calculated by the functions generated or calculated based on the observations 110. As a specific example, the calculated 0.6 of the smooth curve 302. The use of the threshold 322 to determine whether portions of the observations 110 is of the low quality 324 and the usable quality 326 is described later.

In this example shown in FIG. 3, dotted arrows depict some of the mapping from the smooth curve 302 to the stretch curve 304 from the left-side graph to the right-side graph, respectively. The example shown in the right-side graph depicts portions of the observations 110 used to generate the stretch curve 304 from the smooth curve 302.

The stretch curve 304 can be generated utilizing a portion of the observations 110 available to generate the smooth curve 302. For example, the observations 110 from multiple instances of the seasonal group 116 can be utilized. In this example, the observations 110 for a portion of the seasonal group 116 associated with 2016 and a portion of the seasonal group 116 associated with 2017 are used to generate the stretch curve 304. Further, only a portion from each of the seasonal group 116 is utilized and differ between the seasonal group 116. As a specific example, the observations 110 within the past early season 306 for the seasonal group 116 for 2016 is utilized as shown in the right-side graph. Also shown as a specific example, the observations 110 within the past end season 310 for the seasonal group 116 for 2017 is also utilized shown in the right-side graph.

Also further as a specific example, the selection of window for the observations 110 within past early season 306, the past end season 310, or a combination thereof can vary from place to place because farmers adopt different planting timing. In general, the selection window can include an aggregation of the Food and Agriculture Organization (FAO) reported sowing dates, which includes an average of start, median, and end, at 1 km resolution to an administrative units, such as a county for Kenya, to derive the median date, say X, then the window could be [X−90, X+275]. The selection of the window can use remote sensing data to derive the sowing date as well. As a specific example, a fixed selection window of Oct-1st of previous year to Sep-31st of current year works for Africa country as well. The pre-processing from the smooth curve 302 to the stretch curve 304 will be described further later.

For illustrative purposes, the computer system 100, the pre-processing of the observations 110, or a combination thereof in FIG. 3 is shown generating the smooth curve 302 and the stretch curve 304 for a vegetation index, although is understood that the graphs and the observations 110 can represent other types of information. For example, the observations 110 can be from synthetic aperture radar (SAR), space-based monitoring of sun-induced chlorophyll fluorescence (SIF), and thermal signals. The capabilities of SAR for agriculture applications can be organized into three main categories: crop identification and crop planting area statistics, crop and cropland parameter extraction, and crop yield estimation. The space-based monitoring of sun-induced chlorophyll fluorescence (SIF) from terrestrial plants. Also for example, the observations 110 can represent weather conditions, such as rainfall, temperature, humidity, or a combination thereof. The observations 110 can be measure by ground information and not remote sensing by the first device 102 as a satellite. The observations 110 can also be information from databases with information to be pre-processed as shown and described in FIG. 3.

Referring now to FIG. 4, therein is shown an example display of a forecast 402 for the geographic region 112. In this example, the forecast 402 represents a prediction of a crop yield at a given time, date, and the geographic region 112. The forecast 402 is depicted as small boxes in the geographic region 112. In this example, the geographic region 112 can represent a country, a province, a township, a city, a farm, a field, or a combination thereof Given that FIG. 4 is shown in black and white, it is difficult to represent different levels for the forecast 402 for different levels of the crop yield.

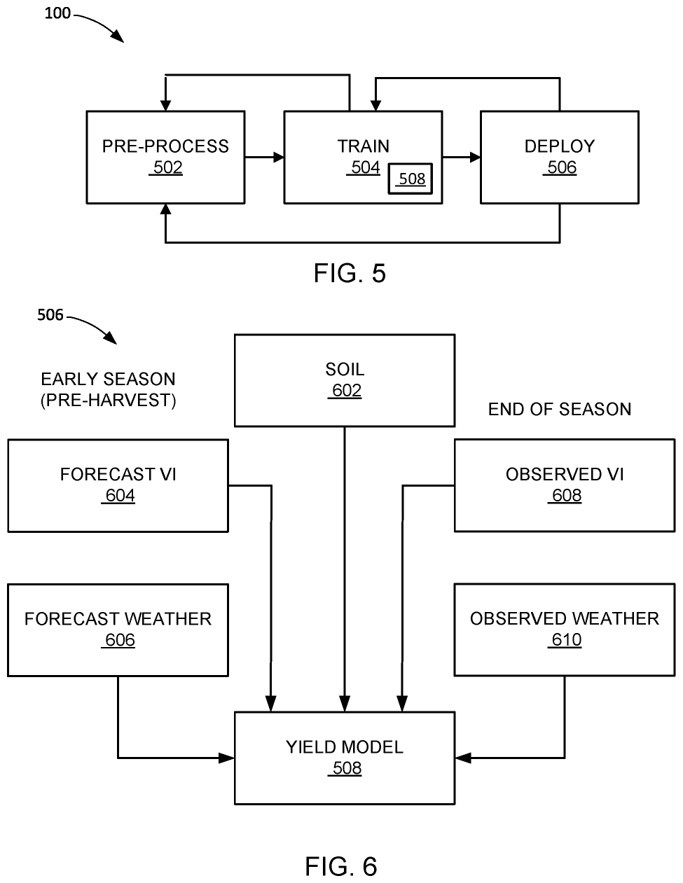

Referring now to FIG. 5, therein is shown an example of a control flow of the computer system 100 with the forecast mechanism. In this example, the control flow includes a pre-process module 502, a train module 504, and a deploy module 506. The pre-process module 502 prepares the input as needed to be processed by a model 508. Examples of the input can be the observations 110 of FIG. 3. The train module 504 performs supervised learning with labeled data, some of which can be prepared by the pre-process module 502. The labeled data refers to an input to the model 508 with known outputs. The observations 110 or the historical observation 118 of FIG. 3 can provide labeled data for the model 508. The deploy module 506 can utilize the model 508 with input other than those generated by the pre-process module 502 and those input into the train module 504.

The control flow can progress from the pre-process module 502 to the train module 504. However, if the performance is not adequate for the model 508 from the train module 504, the flow can loop back to or iterate back to the pre-process module 502 to prepare the observations 110 differently, to select different labeled data, or a combination thereof.

The control flow can progress from the train module 504 to the deploy module 506 if the performance of the model 508 is adequate or meets the target performance metrics from the train module 504. However, the deploy module 506 can loop back or iterate back to the train module 504, the pre-process module 502 if the performance is not adequate for the model 508. Examples of graphical representations for some portions of the pre-process module 502 are described and shown in FIG. 3 and will be further described later. Portions of the train module 504 and the deploy module 506 will be described further later.

As described earlier, the computer system 100 can include the first device 102 of FIG. 1, the communication path 104 of FIG. 1, and the second device 106 of FIG. 1. The first device 102 can send information over the communication path 104 to the second device 106. The second device 106 can send information over the communication path 104 to the first device 102. However, the first device 102 and the second device 106 can be discussed interchangeably.

The control flow can be implemented by the first software 226 of FIG. 2, the second software 242 of FIG. 2, or a combination thereof. The first software 226 and the second software 242 separately, jointly, or individually can be executed by the first control circuit 212 of FIG. 2, the second control circuit 234 of FIG. 2, or a combination thereof.

The first software 226 can be stored in the first storage circuit 214 of FIG. 2 or the second storage circuit 246 of FIG. 2 or distributed between the two. The second software 242 can be stored in the first storage circuit 214 or the second storage circuit 246 or distributed between the two. The control flow can transit commands or to invoke actions utilizing the first communication circuit 216 of FIG. 2, the first communication interface 228 of FIG. 2, the first control interface 222 of FIG. 2, the first storage interface 224 of FIG. 2, or a combination thereof as needed. The control flow can transit commands or to invoke actions utilizing the second communication circuit 236 of FIG. 2, the second communication interface 250 of FIG. 2, the second control interface 244 of FIG. 2, the second storage interface 248 of FIG. 2, or a combination thereof as needed.

The modules described in this application can be stored in the non-transitory computer readable medium. The first storage circuit 214 of FIG. 2, the second storage circuit 246 of FIG. 2, or a combination thereof can represent the non-transitory computer readable medium. The first storage circuit 214, the second storage circuit 246, or a combination thereof, or a portion therein can be removable from the first device 102, the second device 106, or a combination thereof. Examples of the non-transitory computer readable medium can be a non-volatile memory card or stick, an external hard disk drive, a tape cassette, or an optical disk.

Referring now to FIG. 6, therein is shown an example of a control flow of the deploy module 506. In this example, the deploy module 506 can include the model 508 with inputs from a soil module 602 along with inputs from early season and end season. The early season portion includes a forecast VI module 604 and a forecast weather module 606. The end season portion includes an observed VI module 608 and an observed weather module 610.

The model 508 can be expressed by Equation 1 below.

y=β₀+β_{w}×W+βᵥ×VIₚₑₐₖ+βᵢₙₜ₁×W×VIₚₑₐₖ+βᵢₙₜ₂×W×S Equation 1
W: weather
S: Soil
VIₚₑₐₖ: Vegetation Index at peak of some of the satellite indices used to describe the crop progress over a season.
β₀: model coefficient/parameter
β_{w}: model coefficient/parameter for the feature of weather
βᵥ: model coefficient/parameter for the feature of vegetation index
βᵢₙₜ₁: model coefficient/parameter for the features of weather and vegetation index
βᵢₙₜ₂: model coefficient/parameter for the features of weather and soil

The value for β₀, β_{w}, βᵥ, βᵢₙₜ₁, and βᵢₙₜ₂ can be generated by the train module 504 of FIG. 5. As an example, the train module 504 can be purely based on real data, but not necessarily include training samples or possible pseudo training samples. The forecast VI module 604 provides the input to the model 508 for vegetation index for early season. The forecast weather module 606 provides the input to the model 508 for the weather for the early season. The observed VI module 608 provides the input to the model 508 for the vegetation index for the end season. The observed weather module 610 provides the input to the model 508 for the weather for the end season.

If asking where we get the observed VI and weather, as an example, the observed VI module 608 can include the observations 110 of FIG. 1 from satellite remote sensing. Also for example, the observed weather module 610 can include the observations 110 from observed records by meteorology service, either by the government or companies.

In some embodiments, the model 508 can account for spatial variability in soils that could affect the relationship between weather and crop yield. In this example, the model 508 can utilize soil information from the soil module 602. As an example, the soil module 602 can provide a gradient of soil texture and hydraulic properties. In some embodiments, the soil module 602 can provide soil properties for the geographic region 112 of FIG. 4 derived from satellite estimation from the first device 102 or directly from measurement of the soil stored in a database. The model 508 accounts for the soil variability with the weather and an interaction term βᵢₙₜ₂.

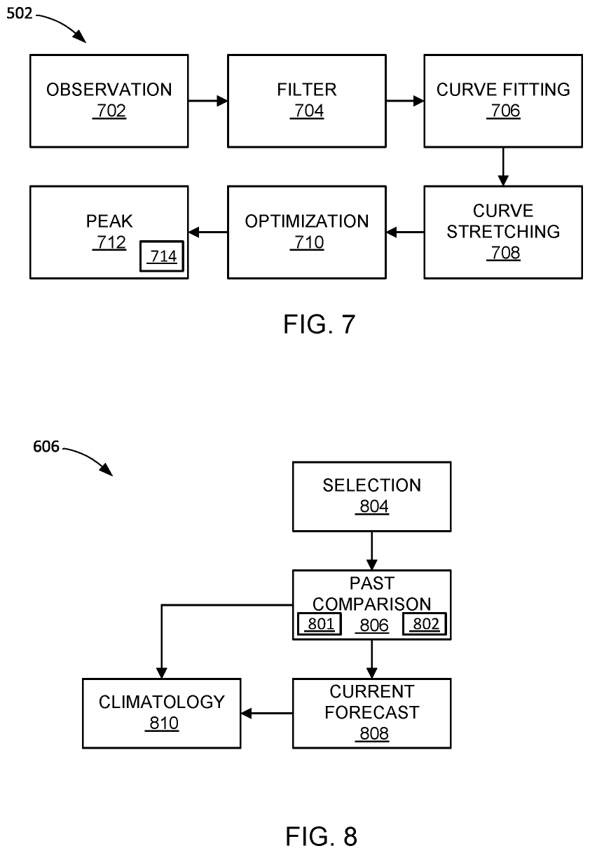

Referring now to FIG. 7, therein is shown an example of a control flow of the pre-processing for climatology. For brevity, the example description of FIG. 7 will be for the vegetation index but can also be applied for weather, similarly to the description in FIG. 3. In this example, the pre-process module 502 of FIG. 5 can provide the smooth curve 302 of FIG. 3 and the stretch curve 304 of FIG. 3 for the forecast VI module 604.

The pre-process module 502 for the vegetation index can include an observation module 702, a filter module 704, a curve fitting module 706, a curve stretching module 708, an optimization module 710, and a peak module 712. As noted earlier, at least some of these modules can also be utilized for weather.

The observation module 702 gathers data for the observations 110 for the first device 102 of FIG. 1 as a satellite. As an example, the observation module 702 can gather the observations 110 from a single satellite or multiple satellites. Also for example, the observation module can obtain satellite observations based on different sensor technologies, such as optical sensors, thermal sensors, microwave sensors, or a combination thereof.

The observation module 702 can also fuse the observations 110 from multiple satellites. The term “fuse” refers to multi-sensor data fusion, which is a process to combine information from multiple sensors, for example, that slightly differ in spatial, temporal and spectral characteristics, to achieve inferences that are not feasible from a single sensor or source. As a specific example, the observation module 702 can combine information from Sentinel-2 and Landsat-8 imagery to help generate the observations 110 in-season and fit the climatology curve as the smooth curve 302, the stretch curve 304, or a combination thereof described in FIG. 3. The observation module 702 can fuse the data from different sources or from different technologies to generate the observations 110 shown in FIG. 3. The flow can progress from the observation module 702 to the filter module 704.

The filter module 704 identifies a smooth approximation to the observations 110. In the example described in FIG. 7, the observations 110 are for the vegetation index (VI). As a specific example, the filter module 704 can fit a Fourier decomposition to the observations 110 (sum of sines and cosines) to produce a smooth time series. The general form is:

$$f ( t ) = d + ct + {\sum }_{k = 1}^{n} [ {a}_{k} cos ( 2 π ω kt ) + {b}_{k} sin ( 2 π ω kt ) ] \qquad Equation 2$$

where ak, bk, c and d are cosine, sine, the intercept and time coefficients, respectively. The term t is the time domain in simulations ranging from 60 days before to 180 days after sowing. In this example, the term c is often set to 0 if only climatology or one-year data is used for the fitting. Also in this example, n=2 can be used for data sparse region. Continuing with this example, the value of ω is the period cycle and is set to 1.2 to match the typical seasonality in East Africa, for example. As examples, the smooth curve 302 can be generated by a local smooth filter or a parametric function. As described earlier, the threshold 322 can be based on the smooth curve 302. For example, the threshold 322 can vary broadly from region to region, but usually consistent when places are close by. The region can be based on agro-ecological zones. As a specific example, the threshold 322 can be set to 0.6.

The curve fitting module 706 generates the smooth curve 302 based on the observations 110. An example of this is shown in FIG. 3. The curve fitting module 706 can utilize the observations 110 generated by the filter module 704. As specific examples, the curve fitting module 706 can utilize single source of satellite imagery or utilize and fuse multiple sources for the satellite imagery for the observations 110. Also as a specific example, if there are the observations 110 for GCVI from Lansdat, Sentinel-2 and Planet (example of three different sensors), they can all be input as the observations 110 to do the harmonic fit, either with equal weighting or with more weight on some sensors than other.

In this example, climatology refers to the average state of GCVI progress over a growing season, which is never directly observable but can be inferred from the observations 110 from the first device 102 as a satellite at different time over multiple years. “Fitting climatology” is a process to find a good parametric model to approximate the “average state” by minimizing the distance to individual instances of the observations 110 from the satellite. Examples of curve fitting can include polynomial regression, trigonometric functions, logistic sigmoid function, least squares, or a combination thereof and an iterative process with a combination thereof. The flow can progress to the curve stretching module 708.

Before discussing the curve stretching module 708, the process of better fitting the smooth curve 302 to the observations 110 can be performed in a number of ways. One example is to use curve stretching if VIₚₑₐₖ date has past. Another example is using the thermal or heat unit if at VIₚₑₐₖ. The appropriate value of VIₚₑₐₖ can be the input to the model 508 of FIG. 5 for Equation 1. In this example, these two approaches are discussed in the following modules.

The curve stretching module 708 further modifies the smooth curve 302 generated by the curve fitting module 706. The curve stretching module 708 generates the stretch curve 304 to further minimize the distance the distance between the smooth curve 302 and the observations 110, such as the satellite observations shown in FIG. 3.

At the time of forecast with the model 508, the model 508 will utilize the stretch curve 304 if peak VI date has passed. Continue with this example, the stretch curve 304 provides more reliability to the forecast generated by the model 508 after the peak VI date has passed (typically 45-60 days after planting). As a specific example, the stretch curve 304 can be stretched vertically and horizontally to fit the observations 110 from the satellite for given any year or season. The shape stretch model in general can be written as Equation 3.

g(x)=y_{scale}×h(x_{scale}×(x₀−x_{shift})−c₁)c₂ Equation 3

h(•): smooth curve

x_scale: parameter to stretch the smooth curve 302 along the x-axis

y_scale: parameter to stretch the smooth curve 302 along the y-axis

x_shift: parameter to move the smooth curve 302 along the x-axis

c1: tuning parameter, shift the smooth curve 302 along x-axis after x_scale and

x_shift operation

c2: tuning parameter, shift the smooth curve 302 along y-axis after y_scale operation

In the example expressed in Equation 3, the parameters x_scale, y_scale and x_shift provide the stretching function applied to the smooth curve 302 while parameters c1 and c2 can be optionally utilized for fine tuning. Parameters can be estimated by minimizing the distance between the observations 110 and the corresponding value on the stretch curve 304. Various computational optimization techniques, such as randomized search, simulated annealing, variance reduction, can be used to get the optimal curve parameters. In this example, the curve stretching module 708 can work with the parameters x_scale, y_scale and x_shift.

The computer system 100, the curve fitting module 706, the curve stretching module 708, or a combination thereof can better fit the smooth curve 302, the stretch curve 304, or a combination thereof utilizing a number of metrics. For example, the distance between the observations 110 and the smooth curve 302, the stretch curve 304, or a combination thereof can be reduced along the x-axis, the y-axis, or a combination thereof with the parameters in Equation 3. An example as a metric for the distance can include least square error. The flow can progress to the optimization module 710.

The optimization module 710 generates a climatology curve 714 based on the stretch curve 304. The optimization module 710 seeks to improve the accuracy or fit of the stretch curve 304 with the climatology curve 714 relative to the observations 110. In this example, the optimization module 710 can utilize the parameters c1, c2, or a combination thereof. The parameters c1, c2, or a combination thereof can be estimated by minimizing the distance between the observations 110 and the corresponding value on the climatology curve 714. Similarly to the curve stretching module 708, the optimization module 710 can operate various computational optimization techniques, such as randomized search, simulated annealing, variance reduction, to generate the optimal curve parameters c1, c2, or a combination thereof to generate the climatology curve 714. The flow can progress to the peak module 712.

The peak module 712 determines the maximum value from the climatology curve 714. A peak date, VI_peak, or a combination thereof can be derived from the climatology curve 714. The peak module 712 can adjust VI_peak based on additions and updates to the observations 110.

For example, if the observations 110 are up-to-date and show that the VI is still growing, then by the time t of forecast with the model 508, peak VI will be estimated with Equation 4.

$${VI}_{p e a k ( t )} = \overline{{VI}_{p e a k}} \times \frac{{VI}_{GDD ( t )}}{\overline{{VI}_{GDD ( t )}}} \qquad Equation 4$$

Equation 4 expresses the current VI relative to the average VI at the same point, or time t, in season based on Growing Degree Day (GDD), then multiply it by the average VI at the peak. That scales the average peak VI by the progress so far in the season.

Growing degree days (GDD) is a weather-based indicator for assessing crop development. It is a calculation used by crop producers that is a measure of heat accumulation used to predict plant and pest development rates such as the date that a crop reaches maturity.

The starting date for accumulating growing degrees days (GDD) can be set as a fixed calendar date and can vary or be specific to a region. The starting date for accumulating GDD can also be determined from time series of satellite imagery with the annotation 114 of FIG. 1 for the observations 110.

As an example, plants can grow effectively between 10-30 C and GDD can be calculated by truncating between the two thresholds with GDD=[min(30, Tmax)+max(10, Tmin)]/2−10 C min(30, Tmax) says if Tmax is greater than 30, should only use 30 for the calculation; likewise, max(10, Tmin)], if Tmin is less than 10, use 10 instead.

Referring now to FIG. 8, therein is shown an example of a control flow of the pre-processing for weather. As described earlier and for brevity, the example description of FIG. 3 and in FIG. 7 can also be applied for the climatology curve 714 of FIG. 7 for weather. In this example, the pre-process module 502 of FIG. 5 can be for the forecast weather module 606.

As an example, weather information can include the observations 110 of FIG. 3 for observed weather data, a current weather forecast 801, a historical weather 802, or a combination thereof. The current weather forecast 801 is short-term or seasonal project of the weather for the current year or crop season. The historical weather 802 includes records of the observations 110 for weather in past years or seasons and can include for multiple years or seasons. Depending on the availability and quality of the current weather forecast 801, the historical weather 802 or the climatology curve 714 can be selected over the current weather forecast 801.

In this example, the forecast weather module 606 can include a selection module 804, a past comparison module 806, a current forecast module 808, a climatology module 810, or a combination thereof. The selection module 804 provides the geographic region 112, time, date, or a combination thereof for operation of the forecast weather module 606. The climatology module 810 can provide the climatology curve 714 for the observations 110 for weather and not for vegetation index.

The past comparison module 806 compares the weather forecast from prior years. If in prior years the historical weather 802 would have improved the skill of then the current weather forecast 801, e.g. reduced out-of-sample root mean square error (RMSE) by an amount greater than 0, than the flow can progress to the current forecast module 808. If not, then the model 508 utilizes climatological values from the climatology curve 714 for the rest of the season from the climatology module 810.

The current forecast module 808 determines a weather forecast to provide for the forecast weather module 606. The current forecast module 808 checks the current weather forecast 801 to ensure that there are no missing values or anomalously low or high values, e.g. exceeding historical extremes by >50% compared to the historical weather 802. If the current weather forecast 801 is not missing values nor contains anomalously low or high values, then the current forecast module 808 provides the current weather forecast 801 for the forecast weather module 606. The length of the weather forecast can vary. For example, the length can range from a few days to a few weeks to a few months. The current weather forecast 801 can be obtained from meteorological service, generated by Weather Research and Forecasting (WRF) Model(s), or a combination thereof. If the current weather forecast 801 includes missing values, anomalous values, or a combination thereof, the flow progresses to the climatology module 810.

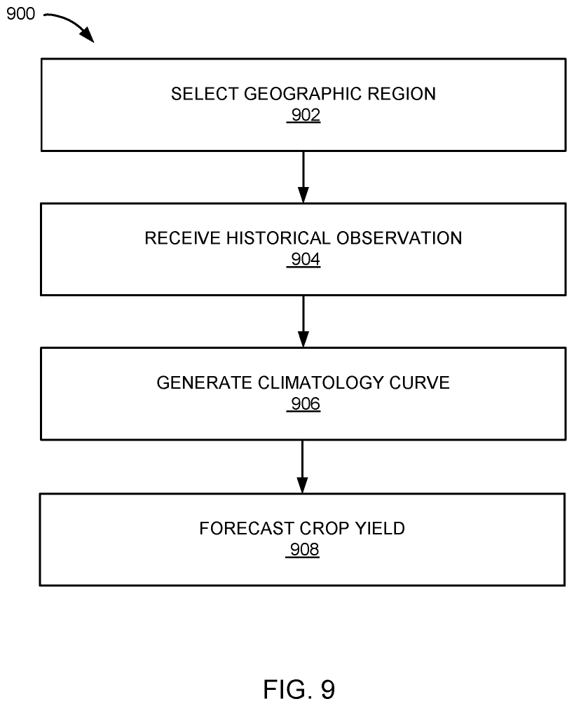

Referring now to FIG. 9, therein is shown a flow chart of a method 900 of operation of a computer system 100 in an embodiment of the present invention. The method 900 includes: selecting a geographic region in a box 902; g receiving a historical observation for the geographic region and the historical observation including a sparse observation at a past middle season in a box 904; generating a climatology curve with the historical observation in a box 906; and generating a crop yield forecast for the geographic region for a current middle season based on the climatology curve in a box 908.

It has been discovered that the computer system 100, the model 508 of FIG. 6, or a combination thereof provides the forecast 402 of FIG. 4, as an example for the crop yield, even there is no or sparse current or historical data by selecting multi-year values for the historical observation 118 of FIG. 5 and generating the climatology curve 714 of FIG. 5 based on this selection of the historical observation 118. The climatology curve 714 allows for the model 508 to generate the forecast 402 that is more accurate despite the sparse data. The climatology curve 714 can be generated for the vegetation index, the weather, or a combination thereof.

It has been further discovered that the computer system 100, the model 508, or a combination thereof provides the forecast 402 for a range of size for the geographic region 112 of FIG. 4 from country level, farm level, field level, or a combination thereof based on the observations 110 of FIG. 5 availability and the climatology curve 714 generated for the level of the geographic region 112.

The physical transformation generated by the computer system 100 effects the actions in the physical world has the model 508 generates the forecast 402. In the example where the forecast 402 is for crop yield, the forecast 402 impacts the physical world in a number of ways. As a specific example, when the forecast 402 is based on the climatology curve 714 and at the current early season 312 of FIG. 3, actions can be taken to improve the crop yield, such as increased water irrigation, increase supplements for the soil or a combination thereof. The observations 110 from the physical world also affect the computer system 100. For example, the computer system 100, the model 508, or a combination thereof can be updated with the observations 110 as the historical observation 118 or the current observation 120. The updates to the model 508 can in turn effect the forecast 402 generated.

The resulting method, process, apparatus, device, product, and system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a computer system comprising:
selecting a geographic region;
receiving a historical observation for the geographic region and the historical observation including a sparse observation at a past middle season;
generating a climatology curve with the historical observation; and
generating a crop yield forecast for the geographic region for a current middle season based on the climatology curve.

2. The method as claimed in claim 1 wherein:
receiving the historical observation includes receiving the historical observation with a non-sparse observation for a past early season and for a past end season;
generating the climatology curve includes generating a smooth curve based on the past early season and the past end season; and
generating the crop yield forecast includes generating the crop yield forecast for a current middle season based on the smooth curve.

3. The method as claimed in claim 1 wherein:
receiving the historical observation includes receiving the historical observation with a non-sparse observation for a past early season and for a past end season;
generating the climatology curve includes generating a stretch curve based on the past early season and the past end season; and
generating the crop yield forecast includes generating the crop yield forecast for a current middle season based on the stretch curve.

4. The method as claimed in claim 1 wherein:
receiving the historical observation includes receiving a historical weather;
further comprising:
determining whether an anomaly exists in a current weather forecast by comparing the current weather forecast with the historical weather; and
generating the crop yield forecast with the current weather forecast when there is no anomaly with the current weather forecast.

5. The method as claimed in claim 1 wherein:
receiving the historical observation includes receiving a historical weather;
further comprising:
determining whether an anomaly exists in a current weather forecast by comparing the current weather forecast with the historical weather; and
generating the crop yield forecast with the climatology curve when there is the anomaly with the current weather forecast.

6. The method as claimed in claim 1 further comprising generating the crop yield forecast for a current end season based on the historical observation.

7. The method as claimed in claim 1 further comprising:
training a yield model with the climatology curve; and
wherein:
generating the crop yield forecast includes generating the crop yield forecast based on the yield model.

8. A computer system comprising:
a control circuit configured to:
select a geographic region;
receive a historical observation for the geographic region and the historical observation including a sparse observation at a past middle season;
generate a climatology curve with the historical observation; and
forecast a crop yield forecast for the geographic region for a current middle season based on the climatology curve; and
a communication circuit, coupled to the control circuit, configured to:
transmit the crop yield forecast for displaying on a device.

9. The system as claimed in claim 8 wherein the control circuit is further configured to:
receive the historical observation with a non-sparse observation for a past early season and for a past end season;
generate the climatology curve includes generating a smooth curve based on the past early season and the past end season; and
forecast the crop yield forecast for a current middle season based on the smooth curve.

10. The system as claimed in claim 8 wherein the control circuit is further configured to:
receive the historical observation with a non-sparse observation for a past early season and for a past end season;
generate the climatology curve includes generating a stretch curve based on the past early season and the past end season; and
forecast the crop yield forecast for a current middle season based on the stretch curve.

11. The system as claimed in claim 8 wherein the control circuit is further configured to:
receive the historical observation includes receiving a historical weather;
determine whether an anomaly exists in a current weather forecast by comparing the current weather forecast with the historical weather; and
forecast the crop yield forecast with the current weather forecast when there is no anomaly with the current weather forecast.

12. The system as claimed in claim 8 wherein the control circuit is further configured to:
receive the historical observation includes receiving a historical weather;
determine whether an anomaly exists in a current weather forecast by comparing the current weather forecast with the historical weather; and
forecast the crop yield forecast with the climatology curve when there is the anomaly with the current weather forecast.

13. The system as claimed in claim 8 wherein the control circuit is further configured to forecast the crop yield forecast for a current end season based on the historical observation.

14. The system as claimed in claim 8 wherein the control circuit is further configured to:
train a yield model with the climatology curve; and
forecast the crop yield forecast includes generating the crop yield forecast based on the yield model.

15. A non-transitory computer readable medium including instructions executable by a control circuit for a computer system comprising:
selecting a geographic region;
receiving a historical observation for the geographic region and the historical observation including a sparse observation at a past middle season;
generating a climatology curve with the historical observation; and
generating a crop yield forecast for the geographic region for a current middle season based on the climatology curve.

16. The non-transitory computer readable medium as claim in claim 15 wherein:
receiving the historical observation includes receiving the historical observation with a non-sparse observation for a past early season and for a past end season;
generating the climatology curve includes generating a smooth curve based on the past early season and the past end season; and
generating the crop yield forecast includes generating the crop yield forecast for a current middle season based on the smooth curve.

17. The non-transitory computer readable medium as claim in claim 15 wherein:
receiving the historical observation includes receiving the historical observation with a non-sparse observation for a past early season and for a past end season;
generating the climatology curve includes generating a stretch curve based on the past early season and the past end season; and
generating the crop yield forecast includes generating the crop yield forecast for a current middle season based on the stretch curve.

18. The non-transitory computer readable medium as claim in claim 15 wherein:
receiving the historical observation includes receiving a historical weather;
further comprising:
determining whether an anomaly exists in a current weather forecast by comparing the current weather forecast with the historical weather; and
generating the crop yield forecast with the current weather forecast when there is no anomaly with the current weather forecast.

19. The non-transitory computer readable medium as claim in claim 15 wherein:
receiving the historical observation includes receiving a historical weather;
further comprising:
determining whether an anomaly exists in a current weather forecast by comparing the current weather forecast with the historical weather; and
generating the crop yield forecast with the climatology curve when there is the anomaly with the current weather forecast.

20. The non-transitory computer readable medium as claim in claim 15 further comprising:
training a yield model with the climatology curve; and
wherein:
generating the crop yield forecast includes generating the crop yield forecast based on the yield model.
